(19) United States
(12) Patent Application Publication
(10) Pub. No.: US 2015/0343248 A1
(43) Pub. Date: Dec. 3, 2015

(54) Portable Fire Extinguisher

(71) Applicant: PYROGEN MANUFACTURING SDN.BHD, Shah Alam, Selangor (MY)

(72) Inventor: CHOI HEE, Shah Alam (MY)

(21) Appl. No.: 14/409,389

(22) PCT Filed: Jun. 7, 2013
(86) PCT No.: PCT/MY13/00105

§ 371 Date: Dec. 18, 2014

(30) Foreign Application Priority Data
Jun. 19, 2012 (MY) PI 2012700392

(51) Int. Cl. A62C 13/00; A62C 13/22

(52) U.S. Cl. CPC A62C 13/006; A62C 13/22

(57) ABSTRACT

A fire extinguisher (100) comprises a tubular casing (110) defining a substantially sealed chamber (111) within that the chamber (111) communicates with the exterior environment by way of an aperture (112) fabricated at one end of the tubular casing (111); a solid propellant (120) stored within a first compartment (111a) of the chamber (111) and capable of being fully transformed into an aerosol, once heated to a predetermined temperature or higher, with fire extinguishing property; an igniting means (130) operative to heat and transform the solid propellant (120) upon turning on a switch (131) which is located outside the chamber (111); and a spray nozzle (140), which is a substantially flat piece tapering from one end to another forming a first (142) and a second opening (143) thereof with the second opening (143) being relatively smaller than the first opening (142), having the second opening (143) mounted onto the aperture (112) to discharge and direct the flow of the generated aerosol through a hollow passage (141) defined within the nozzle (140), wherein the nozzle (140) has thickness of 5 to 30 mm and the first opening (142) has width of 50 to 150 mm.

### FIELD OF INVENTION

The present invention relates to a portable aerosol-type fire extinguisher. More specifically, the fire extinguisher is equipped with a specially designed nozzle to allow the disclosed extinguisher to unlock bonnet of a car without any direct contact with the bonnet in a fire incident happened at the engine compartment.

### BACKGROUND OF THE INVENTION

Conventional fire extinguisher requires a compressed gas container stored within the casing of the extinguisher in order to form a pressurized extinguisher jet. In order to safely keep the compressed gas inside the casing, these extinguishers generally adapt bulky and heavy designs rendering these extinguishers inconvenient to use. To improve portability of these conventional fire extinguishers, extinguishing aerosol-generating solid is employed in current manufactured extinguisher replacing the use of compressed gas. Particularly, potassium carbonate is used as the aerosol-generating solid. It is transformed from solid into an aerosol once heated at a temperature around 300° C. The transformation is exothermic reaction that the heat energy released thereof setoff transformation of the adjacent compounds. The reaction only stops upon consumption of all the available solid potassium carbonate. The generated aerosol contains grains of potassium carbonate which capable of displace air in the proximity of a flame leading to elimination of the flame. Description of aerosol-type portable fire extinguisher can be found in European patent application no. 1479414 and 1484088 as well as International patent with publication no. WO2009/081431. Apart from its light-weighted design and convenient in use, aerosol discharge is known to be less corrosive as well thus suitable in dealing with fire incidents involving mechanical or electronic components like in vehicle engine cabin. Nevertheless, the front bonnet shielding the engine cabin has to be raised up prior to subjecting the flame to the aerosol discharge. Owing to the design of the vehicle, one may have to slide his or her finger under the bonnet to unlock it. Having heat continuously emitted from the engine, unlocking the bonnet using finger may cause substantial burn injuries. Or one may show phobia in unlocking the bonnet, considering the amount of heat produced, and timely extinguishing the fire is prohibited. To facilitate fire fighting in such scenario, portable extinguisher integrated with tool to unlock the bonnet is much preferable. Further, extinguishers in the above mentioned prior arts show significant shortcoming in fighting fire related to engine cabin. Particularly, one may use one hand to hold the bonnet while another hand aim the fire extinguisher and trigger the discharge. Consequently, portable fire extinguisher promoting single-handed operation is more practical as well for fire fighting regarding to the engine cabin of the vehicle

### SUMMARY OF THE INVENTION

The present invention aims to provide a portable fire extinguisher suitable for fire fighting in related to fire incidents happened in engine cabin of a car. Particularly, the disclosed invention is equipped with a specially designed nozzle to allow the user to unlock front bonnet of a car without subjecting to potential burn injuries.

Another object of the present invention is to offer a portable fire extinguisher promoting single-handed operation. More specifically, the disclosed invention bears a discharge triggering mechanism which can be actuated single-handedly.

Further object of the disclosed invention is to provide a fire extinguisher which is spinnable on a substantially flat surface to evenly distribute the aerosol in a confined area, preferably a room.

At least one of the preceding objects is met, in whole or in part, by the present invention, in which one of the embodiments of the present invention is a fire extinguisher comprising a casing defining a substantially sealed chamber within that the chamber communicates with the exterior environment by way of an aperture fabricated at one end of the tubular casing; a solid propellant stored within a first compartment of the chamber and capable of being fully transformed into an aerosol, once heated to a predetermined temperature or higher, with fire extinguishing property; an igniting means operative to heat and transform the solid propellant upon turning on a switch which is located outside the chamber; and a spray nozzle, which is a substantially flat piece defining a hollow passage tapering from one end to another forming a first and a second opening thereof with the second opening being relatively smaller than the first opening, having the second opening mounted onto the aperture to discharge and direct the flow of the generated aerosol through the hollow passage, wherein the nozzle has thickness of 5 to 30 mm and the first opening has width of 50 to 150 mm. To acquire the desired portability, the fire extinguisher of the present invention is preferably weighted in between 0.8 to 2.5 kg.

In another aspect of the present invention, the disclosed extinguisher further comprises ABC powder stored in a second compartment located in between the first compartment and the aperture that the ABC powder is fashioned to be aerated and discharged together with the aerosol through the aperture under an elevated pressure.

In another aspect, the disclosed extinguisher possesses a coolant to absorb excessive heat generated in the solid-aerosol transformation. Relying upon the design of the extinguisher, the coolant can be located in between the first compartment and the aperture or in between the first compartment and the second compartment that the coolant is configured to reduce temperature of the aerosol prior to discharge of the aerosol from the aperture.

In another aspect of the present invention, the internal diameter of the hollow passage gradually increases from the second opening towards the first opening to prepare the aerosol to discharge as high speed jet to effectively displace the surrounding air of the flame.

Another aspect of the disclosed invention is that the disclosed fire extinguisher is spinnable on a substantially flat surface upon discharging the aerosol. Such feature allows the disclosed invention to be thrust into a confined aflame room to evenly distribute the fire extinguishing discharge.

### BRIEF DESCRIPTION OF THE DRAWINGS

FIG. 1 shows a perspective see-through view of one embodiment of the disclosed invention;

FIG. 2 is side view of the embodiment shown in FIG. 1;

FIG. 3 is cross-sectional view of the embodiment shown in FIG. 1;

FIG. 4 is the top view of one embodiment of the nozzle; and

FIG. 5 is a perspective view of one embodiment of the nozzle.

### DETAILED DESCRIPTION OF THE INVENTION

It is to be understood that the present invention may be embodied in other specific forms and is not limited to the sole embodiment described herein. However modification and equivalents of the disclosed concepts such as those which readily occur to one skilled in the art are intended to be included within the scope of the claims which are appended thereto.

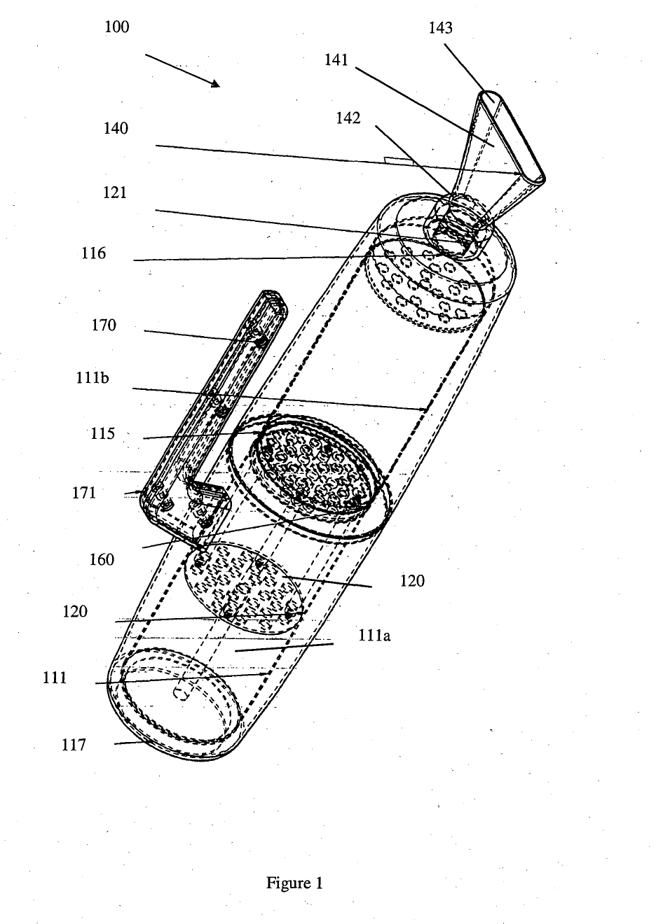

One embodiment of the present invention is a fire extinguisher (100), as illustrated in FIG. 1, comprising a casing (110) defining a substantially sealed chamber (111) within that the chamber (111) communicates with the exterior environment by way of an aperture (112) fabricated at one end of the casing (110); a solid propellant (120) stored within a first compartment (111a) of the chamber (111) and capable of being fully transformed into an aerosol, once heated to a predetermined temperature or higher, with fire extinguishing property; an igniting means (130) operative to heat and transform the solid propellant (120) upon turning on a switch (141) which is located outside the chamber (111); and a spray nozzle (140), which is a substantially flat piece defining a hollow passage (141) tapering from one end to another forming a first (142) and a second opening (143) thereof with the second opening (143) being relatively smaller than the first opening (142), having the second opening (143) mounted onto the aperture (112) to discharge and direct the flow of the generated aerosol through the hollow passage (141), wherein the nozzle (140) has thickness of 5 to 30 mm and the first opening (142) has width of 50 to 150 mm.

Preferably, the casing (110) of the present invention is substantially tubular in shape having one end fabricated with the aperture (112). The casing (111) has the aperture (112) positioned around its center axis at one end. The elongate side of the casing (110) bears a cylindrical outlook without having any angular point. In one embodiment, the casing is composed (110) of two different individual structures, namely an internal (116) and an external casings (117). The internal casing (116) defines the chamber (111) for storing the solid propellant (120) or fuel that the solid-aerosol transformation takes place within the internal casing (116) generating heat and pressure thereof. Hence, the internal casing (116) is produced from material capable withstanding substantial heat and pressure such as metal, alloy or high density plastic. To prevent the external surface (117) of the extinguisher (100) become too hot when the extinguisher (100) is in use, the disclosed invention is designed to minimize heat transfer in between the internal (116) and the external casing (117). In one embodiment, the external casing (117) is made of heat insulating material preferably plastic or any other similar derivatives. Using of the heat insulating material reduces the amount of heat allowed to be transferred to the external casing (117). Further, the disclosed invention minimizes direct contact in between the internal (116) and external casings (117) as well. Shown in FIG. 1, a layer of air (118) are disposed in between the external (117) and internal casings (116) to substantially space apart the internal (116) and the external casings (117) with only mounting formed at the two ends. Particularly, both external (117) and internal casings (116) are fabricated with interlocking groove (119) and configurations at both ends that interlocking configuration facilitates engagement of the two casing to form a single unit. The external casing (117) also carries an annular ring (115) around its middle part to further reinforce engagement in between the two casing (116 and 117) and hold the internal casing (116) in place. A corresponding indented groove may be found on the exterior surface of the internal casing (116) for sliding in of the annular ring (115) thus locking the internal casing (116) to the external casing (117). Presence of the air layer (118) significantly decreases heat transmission through conduction as air is a good insulating material. Moreover, inner surface of the external casing (117) facing the internal casing (116) may be coated with a reflective material to reduce heat transfer via infrared emission. Preferably, the fire extinguisher (100) is weighted 0.8 to 2.5 kg to attain good portability.

According to another preferred embodiment, the chamber (111) defined within the internal casing (116) has more than one compartment besides the one storing the solid propellant (120) or solid fuel. The compartments are separated from one another through mesh piece (122). Through holes on the mesh piece (122) allow the aerosol to flow through one compartment to another until finally being discharged at the aperture (112) on the casing (110).

Preferably, the disclosed extinguisher (100) further comprises ABC powder (123) stored in a second compartment (111b) located in between the first compartment (111a) and the aperture (112) that the ABC powder (123) is fashioned to be aerated and discharged together with the aerosol through the aperture (112) under an elevated pressure. The ABC powder (123) is a mixture of mono ammonium phosphate and ammonium sulphate in a ratio of 20% to 45%:55% to 85%. These powders are water soluble and mildly alkaline. It is important to be noted that the ABC powder (123) can be cleaned via vacuum cleaning or water washing. It is well known that corrosion activity of alkaline solutions towards metal alloys is much less than of acidic solution. Thus, the ABC powder (123) shows almost no corrosion to the vehicle parts when it is used. More preferably, the powder (123) is subjected to hydrophobization prior to filling into the second compartment (111b) to minimize possible negative impacts towards the metal and electrical components. The mixture is specially prepared by the inventors of the present invention to handle fire incidents happened within and around engine cabin of an automobile especially fire caused by gasoline spillage. In contrary to the gas-based fire extinguishing system, the powdery fire extinguishing agent used in one embodiment of the present invention remains on the targeted site to prevent possible recurrence of the fire until the condition is safe to remove the fire extinguishing agent later. Particularly, the ABC powder (123) extinguishes the fire. through two major mechanisms. Firstly, the fire extinguishing agent of the present invention attaches to fire propagating compounds such as oxygen, hydrogen and hydroxyl radicals found on the gasoline in the flame zone thus removing these compounds from the flame zone to discontinue the fire. Secondly, it acts as a fire blanket to shield the surface of the flaming object including gasoline and other fuel types therefore it potentially prevents recurrence of the fire. Further, the ABC powder also carries out series of endothermic reaction like decomposition and/or evaporation upon heated to absorb the surrounding heat to terminate the combustion. It is important that the fire extinguishing aerosol and the ABC powder (123) are charged towards the flame at high speed to immediately rid pyrogenic subject matter off the flame leading to termination of fire incidents. Preferably, the disclosed extinguisher (100) positions a seal (not shown) at the aperture (112) of the casing (110) that this seal is set to readily rupture once the internal pressure of the casing (110) reaches a preferred level. The seal is preferably a membrane or metal foil, more preferably a processed aluminum or copper foil. In one embodiment, the disclosed invention may use seal made of laminated material to permit greater pressure to be built inside the casing (110). For example, a laminate of aluminum foils and/or plastic may be fabricated to produce a stronger seal. Further, scored lines maybe marked onto the seal to fashion the seal to rupture in a preferred way, particularly without prohibiting discharge of the fire extinguishing aerosol and ABC powder (123). Specifically, the scored lines are configured in a preferred pattern serves as the weaker spot first to tear and rupture the seal for discharging the fire extinguishing aerosol and the ABC powder (123).

More preferably, the disclosed extinguisher (100) further comprises a coolant (160) located in between the first compartment (111a) and the second compartment (111b) that the coolant (160) is configured to reduce temperature of the aerosol prior to discharge of the aerosol from the aperture (112). While, in the embodiment without utilizing the ABC powder (123), the disclosed extinguisher (100) has the coolant (160) located in between the first compartment (111a) and the aperture (112) and configured to reduce temperature of the aerosol prior to discharge of the aerosol from the aperture (112). Coolant (160) used in the present invention can be a mechanical coolant or a solid chemical coolant. Particularly, the coolant is positioned in the traveling pathway of the aerosol. The mechanical coolant is fabricated physical part having increased surface area, which is in direct contact with the aerosol, to promote heat exchange in between the passing aerosol and the coolant. The mechanical coolant is preferably made of material with excellent heat conductivity such as various metals or alloys. Moreover, the mechanical coolant may have part of the surface in communication with heat-absorbing gel or clay to increase its heat absorbing capacity. With the existence of the gel or clay, the mechanical coolant is able channel the absorbed heat to the gel or clay. In other embodiment, the solid chemical coolant is preferably a polymer, which is vulnerable against heat-induced decomposition.

Specifically, the chemical coolant decomposes upon heating at a temperature around 200° C. to 300° C. In contrast to the exothermic reaction of the solid propellant (120), decomposition of the solid chemical coolant is an endothermic reaction absorbing the surrounding heat to be transformed into gases. The solid chemical coolant has heat absorbing capacity around 350-450 kcal per kg. Gases derived from the chemical coolant further aids fire extinguishing property of the disclosed invention.

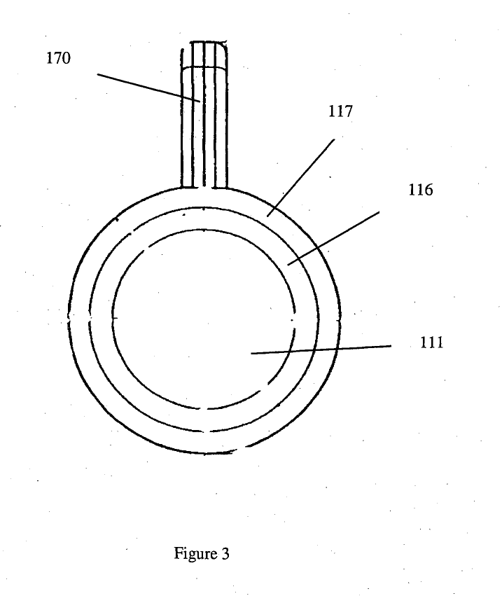

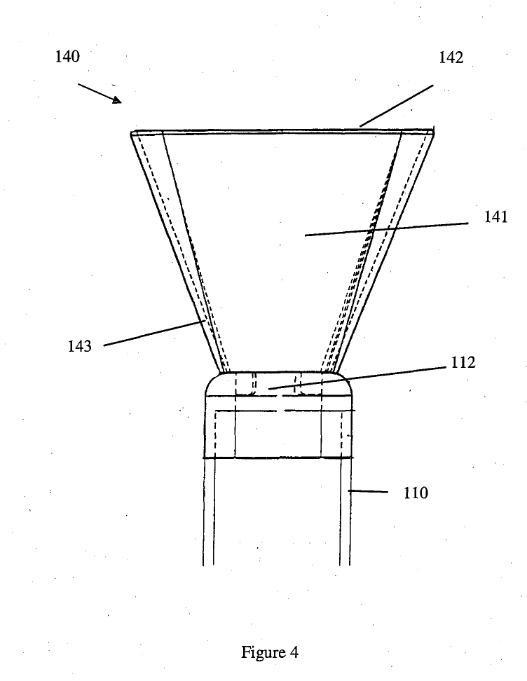

As in the foregoing, the spray nozzle (140) particularly adapts a design facilitating unlocking of the car front bonnet without resorting to user's fingers in the case of a fire incident. The substantially flat piece design of the nozzle (140) having the hollow passage (141) defined within an outer wall. As shown in FIG. 3, being a flat piece allows the nozzle (140) to be inserted into the gap presented in between the car front bonnet and the engine cabin. Sliding the inserted nozzle (141) along the gap shall unlock the car front bonnet. Besides serving as a tool to unlock the bonnet of the engine cabin, the nozzle plays important role as well in preparing the fire-extinguishing jet to charge towards the flame in high speed. The tapering configuration of the hollow passage (141) promotes building up of aerosol pressure within the chamber (111). The pressurized aerosol charges against the flame in high velocity when moving from a high pressure environment to a low pressure environment, caused by abrupt increase in width of the nozzle (140). More preferably, internal diameter or thickness of the hollow passage gradually increases from the second opening (143) towards the first opening (142). Such feature can be achieved through fabricating part of the nozzle (140) adjacent to the second opening (143) with thicker outer wall as in FIG. 4. Thickness of the outer wall is progressively reduced towards the first opening (142). Preferably, the nozzle (140) is detachably mounted onto the aperture (112) but being prevented from rotatable.

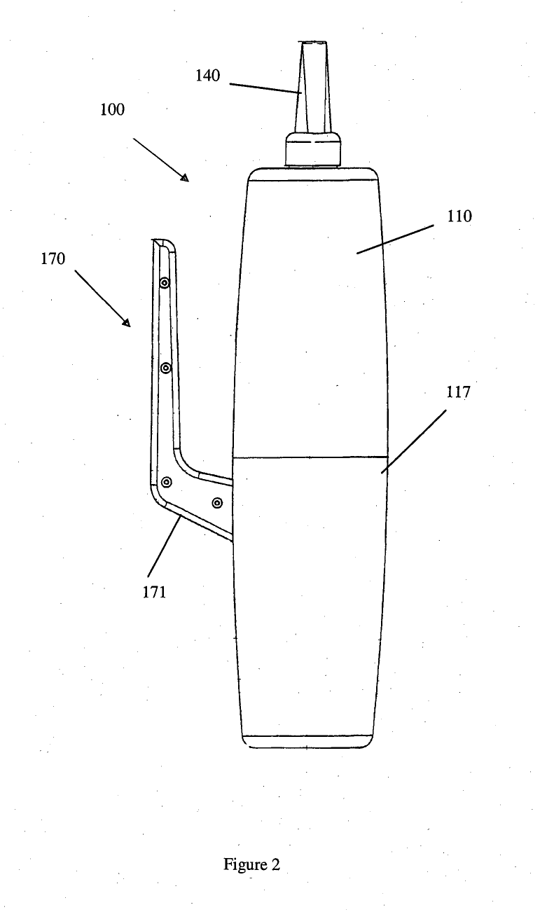

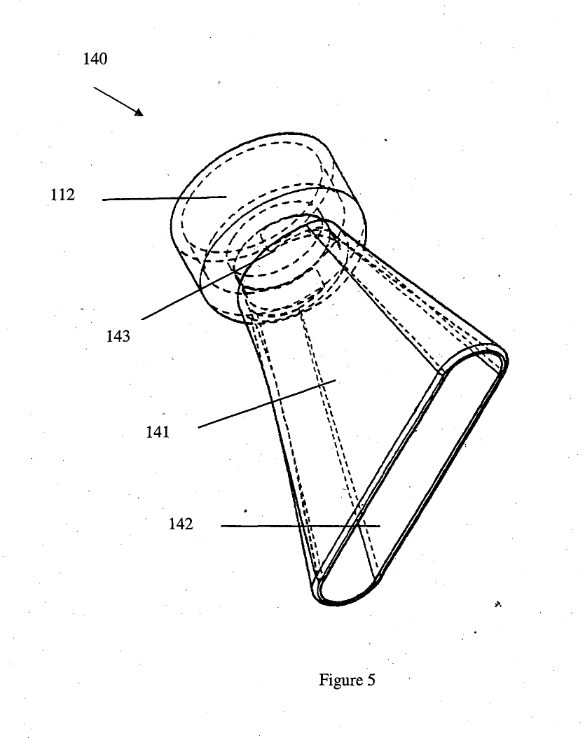

Referring to FIGS. 4 and 5, the disclosed fire extinguisher (100) further comprises a handle (170) mounted onto the tubular casing (110). Referring to FIGS. 1 and 2, the handle (170) of one embodiment of the present invention is substantially L-shaped with tip of the shorter shaft (171) attached onto the exterior surface of the casing (110). Nevertheless, handle (170) of other shape and configuration can be used as well. For example, the handle can be C-shaped or even T-shaped. Apart from that, the disclosed extinguisher (100) is made spinnable on a substantially flat surface upon discharging the aerosol. Discharge of the aerosol from the aperture (112) simultaneously generates a backward propelling force that the generated force is used to spin the disclosed extinguisher (100). More particularly, the disclosed extinguisher (100) carries a smooth exterior surface to favor the spinning by reducing the frictional force generated upon the spinning action. In order to realize the spinning, the generated frictional force has to be significantly lower than the propelling force to allow the spinning attain the desired speed. Further, the disclosed extinguisher (100) is fabricated to have off-center gravity point that the extinguisher (100) tends to tilt at one side to function as anchorage point for spinning. For example, the cylindrical exterior surface of the casing (110) prompts the extinguisher (100) to tilt towards the side mounted with the handle (170) and the handle (170) anchors onto the substantially flat surface where the extinguisher laid. The handle (170) serves as the anchorage point to allow the extinguisher to spin upon discharging the aerosol with further aid from the smooth cylindrical exterior surface. Nonetheless, spinning of the extinguisher (100) can be attained through other approaches. For instance, exterior surface of the casing may carry one or more round-shaped protrusions around its middle portion that the round protrusion is anchorage point to fix the extinguisher on the floor while facilitates the spinning.

Accordingly, the igniting means (130) described herein can refer to electronic initiator or mechanical initiator. More preferably, electronic initiator is employed in the disclosed invention to attain satisfactory performance. Particularly, the disclosed extinguisher (100) provides storage space for the battery of powering up the ignition and simple circuit is implemented as well to join the electronic initiator, the battery and the switch together to activate the solid propellant (120).

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1-8. (canceled)

9. A fire extinguisher, comprising
a casing defining a substantially sealed chamber, wherein the chamber communicates with an exterior environment by way of an aperture formed at one end of the casing;
a solid propellant stored within a first compartment of the chamber and operable to be fully transformed into an aerosol, once heated to a predetermined temperature or higher, with fire extinguishing properties;
an igniting system operable to heat and transform the solid propellant upon actuating a switch located outside of the chamber;
a spray nozzle including a substantially flat piece defining a hollow passage tapering from one end to another end and forming a first and second opening, wherein the second opening is relatively smaller than the first opening, wherein the second opening is mounted onto the aperture to discharge and direct the flow of the aerosol through the hollow passage, wherein the spray nozzle has thickness of 5 to 30 mm and the first opening has width of 50 to 150 mm; and
ABC powder stored in a second compartment located in between the first compartment and the aperture, wherein the ABC powder is operable to be aerated and discharged together with the aerosol through the aperture under an elevated pressure.

10. The fire extinguisher of claim 9, further comprising a coolant located in between the first compartment and the second compartment, wherein the coolant is operable to reduce a temperature of the aerosol prior to discharge of the aerosol from the aperture.

11. The fire extinguisher of claim 9, further comprising a handle mounted on the casing.

12. The fire extinguisher of claim 9, wherein an internal diameter of the hollow passage gradually increases from the second opening towards the first opening.

13. The fire extinguisher of claim 9, wherein the casing is spinnable on a substantially flat surface upon discharging the aerosol.

14. The fire extinguisher of claim 9, wherein the casing, solid propellant, igniting system, spray nozzle, and ABC powder are present in a total weight in the range of 0.8 to 2.5 kg.
